(19) United States
(12) Patent Application Publication
(10) Pub. No.: US 2024/0430301 A1
(43) Pub. Date: Dec. 26, 2024

(54) SYSTEMS AND METHODS FOR DETERMINING SOCIAL ENGINEERING ATTACK USING TRAINED MACHINE-LEARNING BASED MODEL

(71) Applicant: ID.me, Inc., McLean, VA (US)

(72) Inventors: Anand NARASIMHAN, Chicago, IL (US); Natchie Subramaniam THIAGARAJAH, West Chester, PA (US); Greg HORNING, McLean, VA (US); Jason PONG, McLean, VA (US)

(73) Assignee: ID.me, Inc., McLean, VA (US)

(21) Appl. No.: 18/338,675

(22) Filed: Jun. 21, 2023

(51) Int. Cl. H04L 9/40

(52) U.S. Cl. CPC H04L 63/1483; H04L 63/1425; H04L 2463/082

(57) ABSTRACT

A method for automatically determining a social engineering attack on a user account includes: receiving verification data for the user account; extracting diagnostic metadata from the received verification data; extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

### TECHNICAL FIELD

Various embodiments of the present disclosure relate generally to systems and methods for determining a social engineering attack, and, more particularly, to systems and methods for determining a social engineering attack using a trained machine-learning based model.

### BACKGROUND

A fraudster may use a social engineering attack to manipulate a victim to provide identifying information to the fraudster. The fraudster may use the identifying information to gain access and control an account of the victim.

The present disclosure is directed to overcoming one or more of these above-referenced challenges.

### SUMMARY OF THE DISCLOSURE

In some aspects, the techniques described herein relate to a method for automatically determining a social engineering attack on a user account, the method including: receiving verification data for the user account; extracting diagnostic metadata from the received verification data; extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

In some aspects, the techniques described herein relate to a method, further including: receiving verification data for the user account during a verification process of the user account.

In some aspects, the techniques described herein relate to a method, wherein the extracted diagnostic feature determines whether two or more unique individuals are working to complete a single verification of the user account.

In some aspects, the techniques described herein relate to a method, wherein the extracted diagnostic feature includes one or more of: changing a multi-factor authentication type following a verification of the user account, verifying the user account using a first device and a second device geo-located at a threshold distance away from the first device in less than a threshold period of time, or mismatching device user-agent strings or IP addresses during consecutive operations of the verification.

In some aspects, the techniques described herein relate to a method, wherein the trained machine-learning based model excludes any individually identifiable information.

In some aspects, the techniques described herein relate to a method, wherein the automatically determining the social engineering attack based on the extracted diagnostic feature further includes: determining whether the user account is in a high-risk subset of user accounts, as a high-risk score; determining a feature score for the extracted diagnostic feature using the trained machine-learning based model; and determining the social engineering attack based on the determined high-risk score and the determined feature score.

In some aspects, the techniques described herein relate to a method, wherein the extracted diagnostic feature includes a change in a setup for multi-factor authentication in the user account.

In some aspects, the techniques described herein relate to a method, wherein the trained machine-learning based model includes one or more classification models among Support Vector Machine, K-Nearest Neighbors, Logistic Regression, Gaussian-Naive Bayes, Random Forest, Extreme Gradient Boost, and AdaBoost.

In some aspects, the techniques described herein relate to a method, further including: automatically suspending the user account based on the determining the social engineering attack.

In some aspects, the techniques described herein relate to a method, further including: generating an alert when a maximum daily threshold of user accounts is exceeded for the automatically suspending the user account.

In some aspects, the techniques described herein relate to a system for automatically determining a social engineering attack on a user account, the system including: one or more processors configured to perform operations including: receiving verification data for the user account; extracting diagnostic metadata from the received verification data; extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

In some aspects, the techniques described herein relate to a system, wherein the operations further include: receiving verification data for the user account during a verification process of the user account.

In some aspects, the techniques described herein relate to a system, wherein the extracted diagnostic feature determines whether two or more unique individuals are working to complete a single verification of the user account.

In some aspects, the techniques described herein relate to a system, wherein the extracted diagnostic feature includes one or more of: changing a multi-factor authentication type following a verification of the user account, verifying the user account using a first device and a second device geo-located at a threshold distance away from the first device in less than a threshold period of time, or mismatching device user-agent strings or IP addresses during consecutive operations of the verification.

In some aspects, the techniques described herein relate to a system, wherein the trained machine-learning based model excludes any individually identifiable information.

In some aspects, the techniques described herein relate to a system, wherein the automatically determining the social engineering attack based on the extracted diagnostic feature further includes: determining whether the user account is in a high-risk subset of user accounts, as a high-risk score; determining a feature score for the extracted diagnostic feature using the trained machine-learning based model; and determining the social engineering attack based on the determined high-risk score and the determined feature score.

In some aspects, the techniques described herein relate to a system, wherein the extracted diagnostic feature includes a change in a setup for multi-factor authentication in the user account.

In some aspects, the techniques described herein relate to a system, wherein the trained machine-learning based model includes one or more classification models among Support Vector Machine, K-Nearest Neighbors, Logistic Regression, Gaussian-Naive Bayes, Random Forest, Extreme Gradient Boost, and AdaBoost.

In some aspects, the techniques described herein relate to a system, wherein the operations further include: automatically suspending the user account based on the determining the social engineering attack, and generating an alert when a maximum daily threshold of user accounts is exceeded for the automatically suspending the user account.

In some aspects, the techniques described herein relate to a non-transitory computer-readable medium storing instructions that, when executed by one or more processors, cause the one or more processors to perform operations for automatically determining a social engineering attack on a user account, the operations including: receiving verification data for the user account; extracting diagnostic metadata from the received verification data; extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system infrastructure for a system for using artificial intelligence to detect a social engineering attack, according to one or more embodiments.

FIG. 2 depicts a flowchart of a method of using artificial intelligence to detect a social engineering attack, according to one or more embodiments.

FIG. 3 depicts an exemplary implementation of a controller that may execute techniques presented herein, according to one or more embodiments.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value. In this disclosure, unless stated otherwise, “automatically” is used to indicate that an operation is performed without user input or intervention.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to systems and methods for determining a social engineering attack, and, more particularly, to systems and methods for determining a social engineering attack using a trained machine-learning based model. One or more embodiments may identify socially engineered accounts in near real time. Information from a vendor or other third-party member may be received in real time. One or more embodiments may use a combination of rules and machine learning techniques to identify social engineering scams.

In social engineering attacks, a fraudster may initiate a verification (such as an account creation or consent initiation, for example) and may rely on a victim to provide the necessary personally identifiable information to allow the fraudster to complete the verification. For example, a fake job offer scam may trick a victim into providing personally identifiable information under the pretext of a background check, or a fraudster may use a romance scam. These social engineering scams are growing at an exponential rate with technology. Evidence suggests that social engineering scamming is becoming an industry itself outside of the United States. There are also organized groups within the United States that target the Internal Revenue Service, state work force agencies, and Social Security Administration, for example, via socially engineered identities.

One or more embodiments may detect a socially engineered identity during a verification process. One or more embodiments may adhere to National Institute of Standards (NIST) Digital Identity Guidelines, NIST 800-63-3. These guidelines may be used by federal agencies to verify that people are who they say they are before being granted access to restricted information or accounts. One or more embodiments may provide an automatic suspension rule for an account.

Social engineering attacks may involve a fraudster manipulating a victim to provide personally identifiable information to the fraudster. The fraudster may then set up an account using the personally identifiable information without the victim's knowledge. The victim may then be deceived to perform other steps of a verification process, such as a device possession check, liveness check, and multifactor authentication. This deception may enable the fraudster to successfully verify and control an account with the victim's information, which may enable the fraudster to submit an application posing as the victim, such as for unemployment relief funds, for example.

One or more embodiments may provide a trained machine-learning based model to identify social engineering attacks. One or more embodiments may provide model features that determine whether two or more unique individuals are working to complete a single verification. These features consider only device information and user behavior during successful verification that have been observed having high correlation to known social engineering occurrences. Examples of the behaviors may include changing multi-factor authentication types post verification, using devices that are geo-located at unrealistic distances away from each other in a short period of time, and mismatching device User-Agent strings or IP addresses during consecutive verification operations.

The model has no visibility into user information at a personal level and does not consider gender, race, ethnicity, age, or social status. The model also does not consider where the user lives, or the partners for which a user has consented. As a result, the model is not capable of differentiating any individually identifiable information.

One or more embodiments may implement rules that identify a high risk subset of the population to pair with the model scores. These rules may add an extra level of scrutiny on top of the trained machine-learning based model, and may further reduce a false positive rate. For example, one or more embodiments may first look for an account verified as a high risk subset, and then flag an account with a model score above 0.95. However, the embodiments are not limited thereto, and model scores other than 0.95, such as 0.86 or 0.98, for example, may be used. The high risk subset may be agnostic to age, gender, and race. One or more embodiments may flag only an account that has a very high probability of being fraudulent. One or more embodiments may include measures taken during sample selection, feature selection, model selection, testing, and validation to ensure the model does not exhibit bias.

One or more embodiments may use training and testing samples selected from a pool of existing verified accounts, such as accounts verified at Identity Assurance Level 2. One or more embodiments may identify accounts that are socially engineered so that the trained machine-learning based model is effectively trained on accurate socially engineered fraud labels. One or more embodiments may acquire a target population by selecting only users with an active “fraudulent” fraud status and identified with a term such as “social engineering” included in a fraud vector. One or more embodiments may use a statistically relevant population to ensure that the model is learning only from information that is accurate.

One or more embodiments may be designed around key indicators of social engineering attacks. These types of features may include, but are not limited to: (1) notable changes in an individual's personally identifiable information, such as a social security number or date of birth, for example, which may indicate that the individual is trying different personally identifiable information or using unfamiliar personally identifiable information, and (2) how the individual uses two-factor authentication, such as a type of multi-factor authentication used or a change in a setup for multi-factor authentication in an account, as certain two-factor authentication options occur more often in fraudulent verifications, and changes in setup for multi-factor authentication may indicate that an account has been taken over by another individual.

The majority of non-fraudulent users use text or call multi-factor authentication at least half of the time, while the fraudulent population does not use text or call approximately two-thirds of the time. The majority of non-fraudulent users do not use a specific multi-factor authentication method, such as a code generator, for example, while the fraudulent population uses a specific multi-factor authentication method about half of the time.

Virtual Private Network or Dedicated Channel usage may indicate an attempt to obfuscate an individual's identity. High shared device fingerprint counts may indicate a single individual is controlling multiple accounts. Using multiple IP addresses or discrepancies in the IP geolocation during verification may indicate more than one individual is involved in an account setup. Non-fraudulent users typically only share device fingerprints with other users in the same proximity such as within the same city, state, or latitude and longitude, for example), while fraudulent users often share a fingerprint with users living in different geographical locations. Typically, non-fraudulent users use the same IP address throughout the verification process, while fraudulent users use different IP addresses, indicating that multiple individuals may be involved in the verification.

Patterns of use of an account, including account longevity and additional verifications and consents (such as with other partner members, for example) may help indicate whether an account is being used for benign or malicious intentions. Classification models may include Support Vector Machine, K-Nearest Neighbors, Logistic Regression, Gaussian-Naive Bayes, Random Forest, Extreme Gradient Boost, and AdaBoost, through five different performance metrics, including F1, recall, precision, accuracy, and receiver operating characteristic.

In addition to checking the model performance in the validation sample, the model was put into rigorous manual scrutiny by investigators. Samples from the unlabeled accounts were chosen based on model score thresholds 0.85, 0.9, 0.95, and 0.975. Accounts were then sent for manual investigation over a period of one month and the false positive rates were monitored. The model score threshold 0.95 provides the widest coverage while maintaining false positive ratios below 1%.

One or more embodiments may provide a system for automatic suspension of an account, based on a determined social engineering attack. One or more embodiments may provide a system for flagging an account, based on a determined social engineering attack, for manual review. One or more embodiments may provide a trained machine-learning based model to identify a social engineering attack, with a false positive rate below 1%. One or more embodiments may provide a system that is prohibited from overwriting prior or future human decisions. This control may limit the scope of automated decision-making to accounts that have not been investigated by a human.

One or more embodiments may include a maximum daily threshold for automated suspension at a rule/model level. For example, if a maximum daily threshold of 40 automated suspensions is met or exceeded, the process may generate an email-based alert to the data and fraud teams, and the entire process may halt and wait for manual dispositioning. However, the embodiments are not limited thereto. For example, the maximum daily threshold may be 0.2% of all accounts. This control may ensure the system is operating within expected boundaries.

One or more embodiments may monitor each account that is automatically suspended for future status changes, and use the monitoring data to evaluate system performance. One or more embodiments may evaluate the model on a weekly basis on false positive rates. One or more embodiments may halt automatic suspensions when the false positive rate exceeds 1%.

One or more embodiments may exclude any socio-demographic information in the model training, testing, and validation. One or more embodiments may have an inability to differentiate along gender, race, or age. A comparison of the gender distribution of the accounts that are flagged by the automatic suspension rule to the gender distribution of the accounts that are flagged by investigators may show no significant differences in the gender distribution between manual labeling and automatic labeling. A comparison of the age distribution of the accounts flagged by the automatic suspension rule to the age distribution of the accounts that are flagged by investigators may show no significant differences in the age distribution between manual labeling and automatic labeling. Using a Fitzpatrick scale for skin tone ranking, a comparison of the racial distribution between manual labeling and automatic labeling may show no significant differences in the skin tone distribution between manual labeling and automatic labeling.

One or more embodiments may provide a system to identify a victim of a social engineering attack, while reducing incorrect identification of non-fraudulent individuals. One or more embodiments may provide a system to identify specific social engineering techniques, such as situations with different individuals involved in completing a single verification. One or more embodiments may provide a system to identify these attacks without user bias and while being agnostic to any social identities such as gender, race, ethnicity, or social status. One or more embodiments may provide a system with an automatic suspension rule able to capture up to 40% of socially engineered attacks, while maintaining false positive rates below 1%. One or more embodiments may provide a system that does not differentiate accounts based on socio-demographic information.

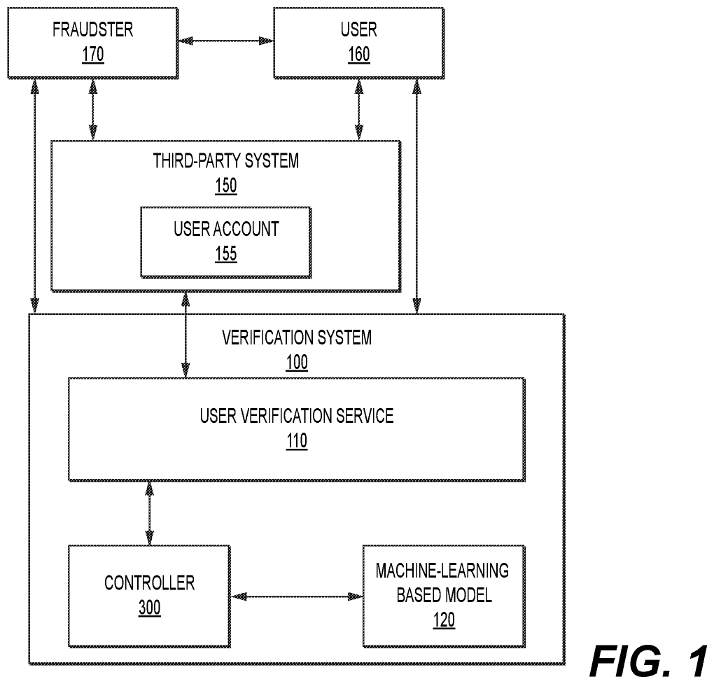

FIG. 1 depicts an exemplary system infrastructure for a verification system for using artificial intelligence to detect a social engineering attack, according to one or more embodiments. Verification system 100 may include a user verification service 110, controller 300, and trained machine-learning based model 120. Verification system 100 may communicate with a third-party system 150. Third-party system 150 may include a user account 155. Third-party system 150 may use verification system 100 to verify an initial setup for user account 155 and/or to allow access to user account 155. User account 155 may be attempted to be initialized or accessed by one or more of a user 160 or a fraudster 170.

Trained machine-learning based model 120 may be instructions 324 stored in a memory 304 of controller 300. The trained machine-learning based model 120 that may be useful and effective for the analysis is a neural network, which is a type of supervised machine learning. However, other machine learning techniques and frameworks may be used to perform the methods contemplated by the present disclosure. For example, the systems and methods may be realized using other types of supervised machine learning, such as regression problems or random forest, for example, using unsupervised machine learning such as cluster algorithms or principal component analysis, for example, and/or using reinforcement learning. The trained machine-learning based model 120 may alternatively or additionally be rule-based.

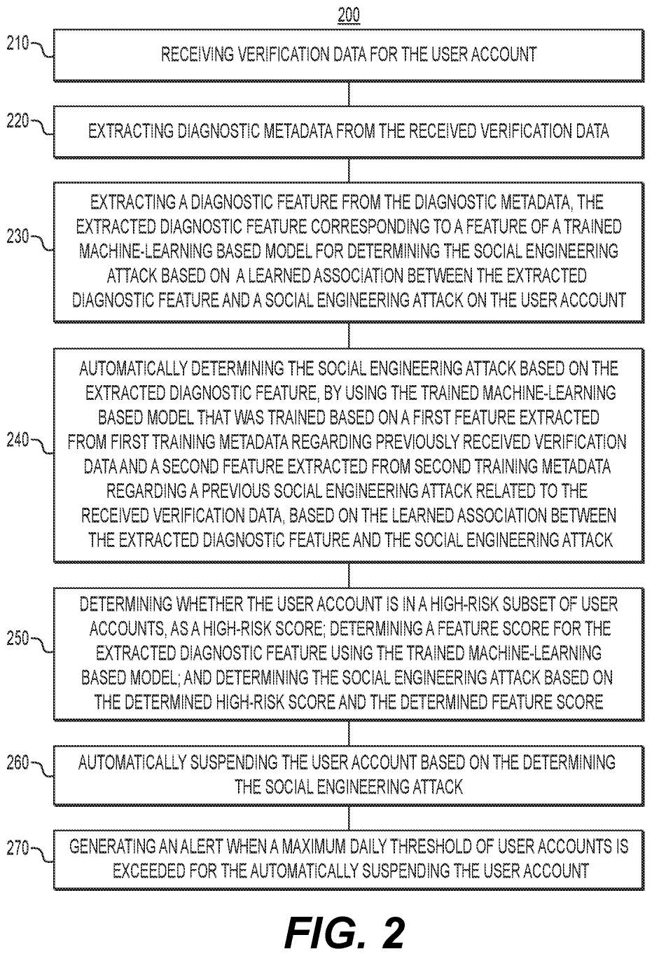

FIG. 2 depicts a flowchart of a method of using artificial intelligence to detect a social engineering attack, according to one or more embodiments. A method 200 for automatically determining a social engineering attack may include various operations, which may be executed by controller 300, for example.

Method 200 for automatically determining a social engineering attack on a user account may include receiving verification data for the user account (operation 210). For example, the verification data for the user account may be received during a verification process of the user account. Method 200 may include extracting diagnostic metadata from the received verification data (operation 220).

Method 200 may include extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account (operation 230). The extracted diagnostic feature may determine whether two or more unique individuals are working to complete a single verification of the user account. The extracted diagnostic feature may include one or more of: changing a multi-factor authentication type following a verification of the user account, verifying the user account using a first device and a second device geo-located at a threshold distance away from the first device in less than a threshold period of time, or mismatching device user-agent strings or IP addresses during consecutive operations of the verification. The extracted diagnostic feature may include one or more of: a change in personally identifiable information of a user of the user account, or a change in a setup for multi-factor authentication in the user account.

Method 200 may include automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack (operation 240). The trained machine-learning based model may exclude any individually identifiable information. The trained machine-learning based model may include one or more classification models among Support Vector Machine, K-Nearest Neighbors, Logistic Regression, Gaussian-Naive Bayes, Random Forest, Extreme Gradient Boost, and AdaBoost, and one or more performance metrics among F1, recall, precision, accuracy, and receiver operating characteristic.

The automatically determining the social engineering attack based on the extracted diagnostic feature (operation 240) may further include: determining whether the user account is in a high-risk subset of user accounts, as a high-risk score, determining a feature score for the extracted diagnostic feature using the trained machine-learning based model, and determining the social engineering attack based on the determined high-risk score and the determined feature score (operation 250).

Method 200 may include automatically suspending the user account based on the determining the social engineering attack (operation 260). Method 200 may include generating an alert when a maximum daily threshold of user accounts is exceeded for the automatically suspending the user account (operation 270).

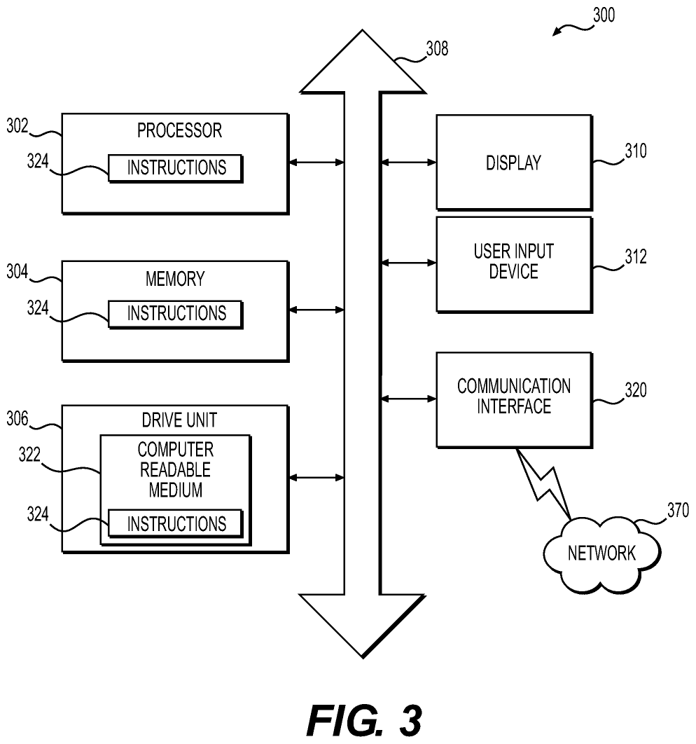

FIG. 3 depicts an exemplary implementation of a controller that may execute techniques presented herein, according to one or more embodiments. The controller 300 may include a set of instructions that can be executed to cause the controller 300 to perform any one or more of the methods or computer based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 can be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that can communicate via a bus 308. The memory 304 may be a main memory, a static memory, or a dynamic memory. The memory 304 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of a processor, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 300 may further include a display 310, such as a liquid crystal display (LCD), an organic light emitting diode (OLED), a flat panel display, a solid-state display, a cathode ray tube (CRT), a projector, a printer or other now known or later developed display device for outputting determined information. The display 310 may act as an interface for the user to see the functioning of the processor 302, or specifically as an interface with the software stored in the memory 304 or in the drive unit 306.

Additionally or alternatively, the controller 300 may include an input device 312 configured to allow a user to interact with any of the components of controller 300. The input device 312 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 322 in which one or more sets of instructions 324, e.g. software, can be embedded. Further, the instructions 324 may embody one or more of the methods or logic as described herein. The instructions 324 may reside completely or partially within the memory 304 and/or within the processor 302 during execution by the controller 300. The memory 304 and the processor 302 also may include computer-readable media as discussed above.

In some systems, a computer-readable medium 322 includes instructions 324 or receives and executes instructions 324 responsive to a propagated signal so that a device connected to a network 370 can communicate voice, video, audio, images, or any other data over the network 370. Further, the instructions 324 may be transmitted or received over the network 370 via a communication port or interface 320, and/or using a bus 308. The communication port or interface 320 may be a part of the processor 302 or may be a separate component. The communication port or interface 320 may be created in software or may be a physical connection in hardware. The communication port or interface 320 may be configured to connect with a network 370, external media, the display 310, or any other components in controller 300, or combinations thereof. The connection with the network 370 may be a physical connection, such as a wired Ethernet connection or may be established wirelessly as discussed below. Likewise, the additional connections with other components of the controller 300 may be physical connections or may be established wirelessly. The network 370 may alternatively be directly connected to a bus 308.

While the computer-readable medium 322 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 322 may be non-transitory, and may be tangible.

The computer-readable medium 322 can include a solid-state memory such as a memory card or other package that houses one or more non-volatile read-only memories. The computer-readable medium 322 can be a random-access memory or other volatile re-writable memory. Additionally or alternatively, the computer-readable medium 322 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 300 may be connected to a network 370. The network 370 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 370 may include wide area networks (WAN), such as the Internet, local area networks (LAN), campus area networks, metropolitan area networks, a direct connection such as through a Universal Serial Bus (USB) port, or any other networks that may allow for data communication. The network 370 may be configured to couple one computing device to another computing device to enable communication of data between the devices. The network 370 may generally be enabled to employ any form of machine-readable media for communicating information from one device to another. The network 370 may include communication methods by which information may travel between computing devices. The network 370 may be divided into sub-networks. The sub-networks may allow access to all of the other components connected thereto or the sub-networks may restrict access between the components. The network 370 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for automatically determining a social engineering attack on a user account, the method comprising:
receiving verification data for the user account;
extracting diagnostic metadata from the received verification data;
extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and
automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

2. The method of claim 1, further comprising:
receiving verification data for the user account during a verification process of the user account.

3. The method of claim 1, wherein the extracted diagnostic feature determines whether two or more unique individuals are working to complete a single verification of the user account.

4. The method of claim 1, wherein the extracted diagnostic feature includes one or more of:
changing a multi-factor authentication type following a verification of the user account,
verifying the user account using a first device and a second device geo-located at a threshold distance away from the first device in less than a threshold period of time, or
mismatching device user-agent strings or IP addresses during consecutive operations of the verification.

5. The method of claim 1, wherein the trained machine-learning based model excludes any individually identifiable information.

6. The method of claim 1, wherein the automatically determining the social engineering attack based on the extracted diagnostic feature further comprises:
determining whether the user account is in a high-risk subset of user accounts, as a high-risk score;
determining a feature score for the extracted diagnostic feature using the trained machine-learning based model; and
determining the social engineering attack based on the determined high-risk score and the determined feature score.

7. The method of claim 1, wherein the extracted diagnostic feature includes a change in a setup for multi-factor authentication in the user account.

8. The method of claim 1, wherein the trained machine-learning based model includes one or more classification models among Support Vector Machine, K-Nearest Neighbors, Logistic Regression, Gaussian-Naive Bayes, Random Forest, Extreme Gradient Boost, and AdaBoost.

9. The method of claim 1, further comprising:
automatically suspending the user account based on the determining the social engineering attack.

10. The method of claim 9, further comprising:
generating an alert when a maximum daily threshold of user accounts is exceeded for the automatically suspending the user account.

11. A system for automatically determining a social engineering attack on a user account, the system comprising:
one or more processors configured to perform operations including:
receiving verification data for the user account;
extracting diagnostic metadata from the received verification data;
extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and
automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.

12. The system of claim 11, wherein the operations further comprise:
receiving verification data for the user account during a verification process of the user account.

13. The system of claim 11, wherein the extracted diagnostic feature determines whether two or more unique individuals are working to complete a single verification of the user account.

14. The system of claim 11, wherein the extracted diagnostic feature includes one or more of:
changing a multi-factor authentication type following a verification of the user account,
verifying the user account using a first device and a second device geo-located at a threshold distance away from the first device in less than a threshold period of time, or
mismatching device user-agent strings or IP addresses during consecutive operations of the verification.

15. The system of claim 11, wherein the trained machine-learning based model excludes any individually identifiable information.

16. The system of claim 11, wherein the automatically determining the social engineering attack based on the extracted diagnostic feature further comprises:
determining whether the user account is in a high-risk subset of user accounts, as a high-risk score;
determining a feature score for the extracted diagnostic feature using the trained machine-learning based model; and
determining the social engineering attack based on the determined high-risk score and the determined feature score.

17. The system of claim 11, wherein the extracted diagnostic feature includes a change in a setup for multi-factor authentication in the user account.

18. The system of claim 11, wherein the trained machine-learning based model includes one or more classification models among Support Vector Machine, K-Nearest Neighbors, Logistic Regression, Gaussian-Naive Bayes, Random Forest, Extreme Gradient Boost, and AdaBoost.

19. The system of claim 11, wherein the operations further comprise:
automatically suspending the user account based on the determining the social engineering attack, and
generating an alert when a maximum daily threshold of user accounts is exceeded for the automatically suspending the user account.

20. A non-transitory computer-readable medium storing instructions that, when executed by one or more processors, cause the one or more processors to perform operations for automatically determining a social engineering attack on a user account, the operations comprising:
receiving verification data for the user account;
extracting diagnostic metadata from the received verification data;
extracting a diagnostic feature from the diagnostic metadata, the extracted diagnostic feature corresponding to a feature of a trained machine-learning based model for determining the social engineering attack based on a learned association between the extracted diagnostic feature and a social engineering attack on the user account; and
automatically determining the social engineering attack based on the extracted diagnostic feature, by using the trained machine-learning based model that was trained based on a first feature extracted from first training metadata regarding previously received verification data and a second feature extracted from second training metadata regarding a previous social engineering attack related to the received verification data, based on the learned association between the extracted diagnostic feature and the social engineering attack.
